(19) United States
(12) Patent Application Publication
(10) Pub. No.: US 2003/0131486 A1
(43) Pub. Date: Jul. 17, 2003

(54) Trim setting gauge

(76) Inventor: William Patrick Wallace, Union City, NJ (US)

Correspondence Address: William Patrick Wallace, 1500 Manhattan Avenue, Union City, NJ, 07087, US

(21) Appl. No.: 10/228,315

(22) Filed: Aug. 26, 2002

Related U.S. Application Data
(60) Provisional application No. 60/318,495, filed on Sep. 10, 2001.

(51) Int. Cl. G01D 21/00

(52) U.S. Cl. 33/194

(57) ABSTRACT

The TRIM SETTING GAUGE is a tool comprised of a 90* outer casing, strengthened by a web inner body and having an adjustable “sliding blade” which is set at the desired measurement and made fast by a pin which has a grip to fit the channel in the “slid blade.” The pin has a tension spring and lock nut to ensure no movement of the “slid blade” after setting.

Following is a physical description of Trim setting gauge, a unique and novel tool utilized in wood working. Its function is to provide an accurate way to measure the desired margin at which to install trim casing. TRIM SETTING GAUGE has various parts. There is a metal blade that is marked in 1/16″ and millimeters. This blade slides in and out to provide the margin measurement. A lock nut is used to adjust the blade in the channel. There is also a marking pin built into the casing. TRIM SETTING GAUGE may be constructed of either metal or plastic. Note the design sketch and photo image for a more complete representation of this design. TRIM SETTING GAUGE should find a wide market among carpenters, cabinet makers, general construction workers, model builders, boat builders, sign builders, handy men, home owners and hobbyists.

Prior devices for setting the desired margin for trim casing:

A: They are a set measurement or

B: They are set at a 90* angle and have to be used twice to achieve the desired margin.

### BRIEF SUMMARY OF THE INVENTION

The TRIM SETTING GAUGE is a woodworking tool used to set trim casing in the carpentry field. It allows the trim casing to be installed at the desired margin by adjusting the blade to the required depth. The depth is determined using the front markings—1/16″ and/or mm.—on the adjustable blade.

### BRIEF DESCRIPTION

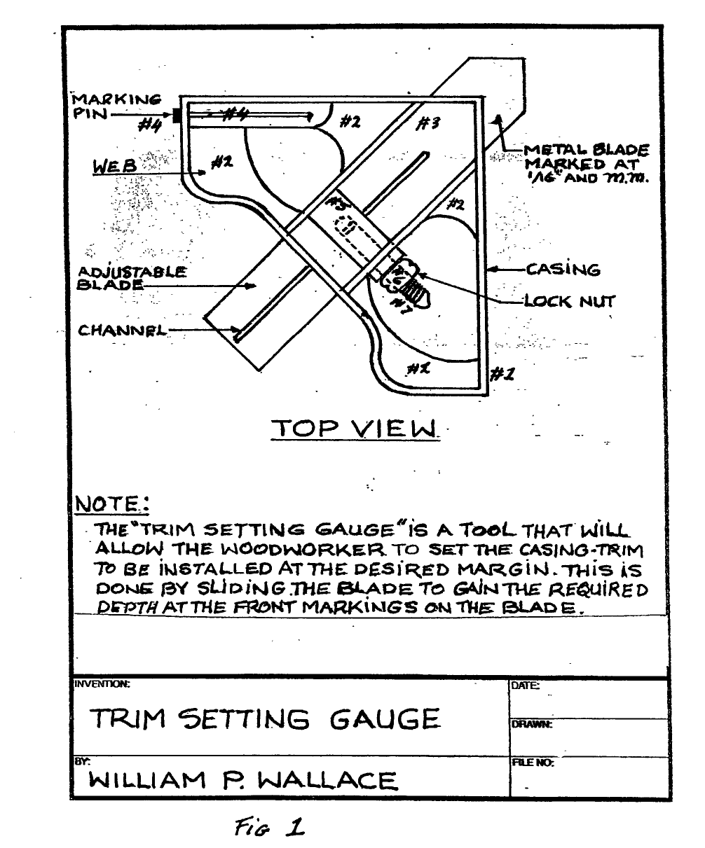

FIG. 1 is a perspective view of the trim setting gauge tool of the invention used to set the desired margin when installing trim/casing in the carpentry field.

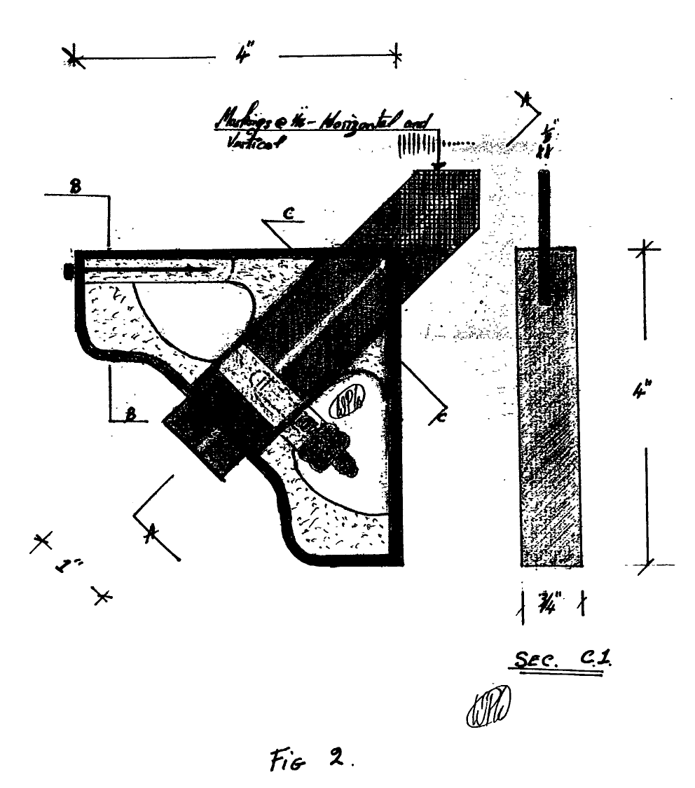

FIG. 2 is a perspective view of the trim setting gauge showing sections related parts and section C1.

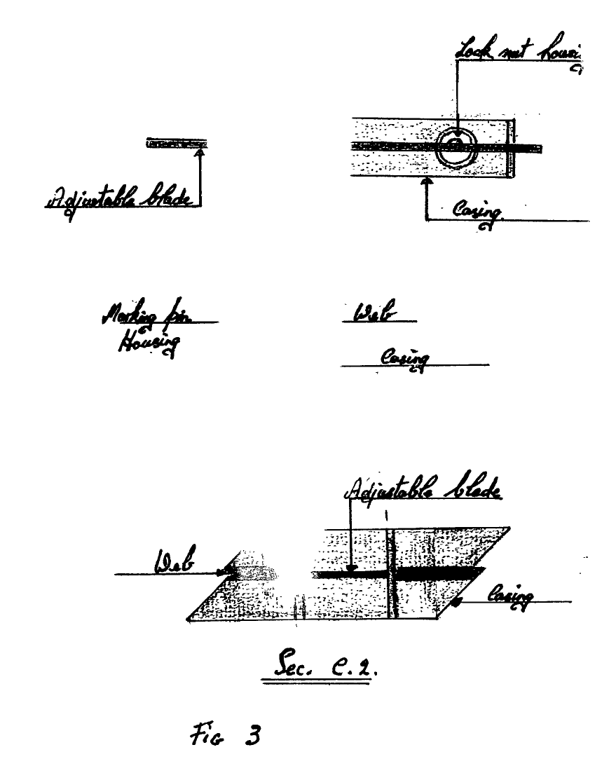

FIG. 3 is three sectional views of the trim setting gauge, Section A section Band section C2.

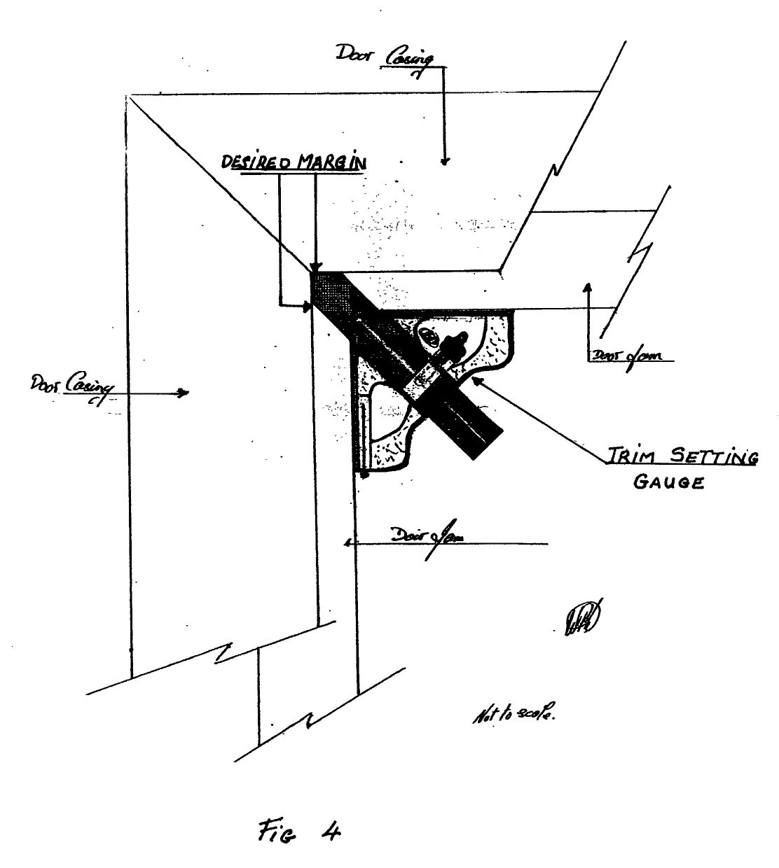

FIG. 4 is a perspective view of a door jam and casing with the trim setting gauge in the correct starting location.

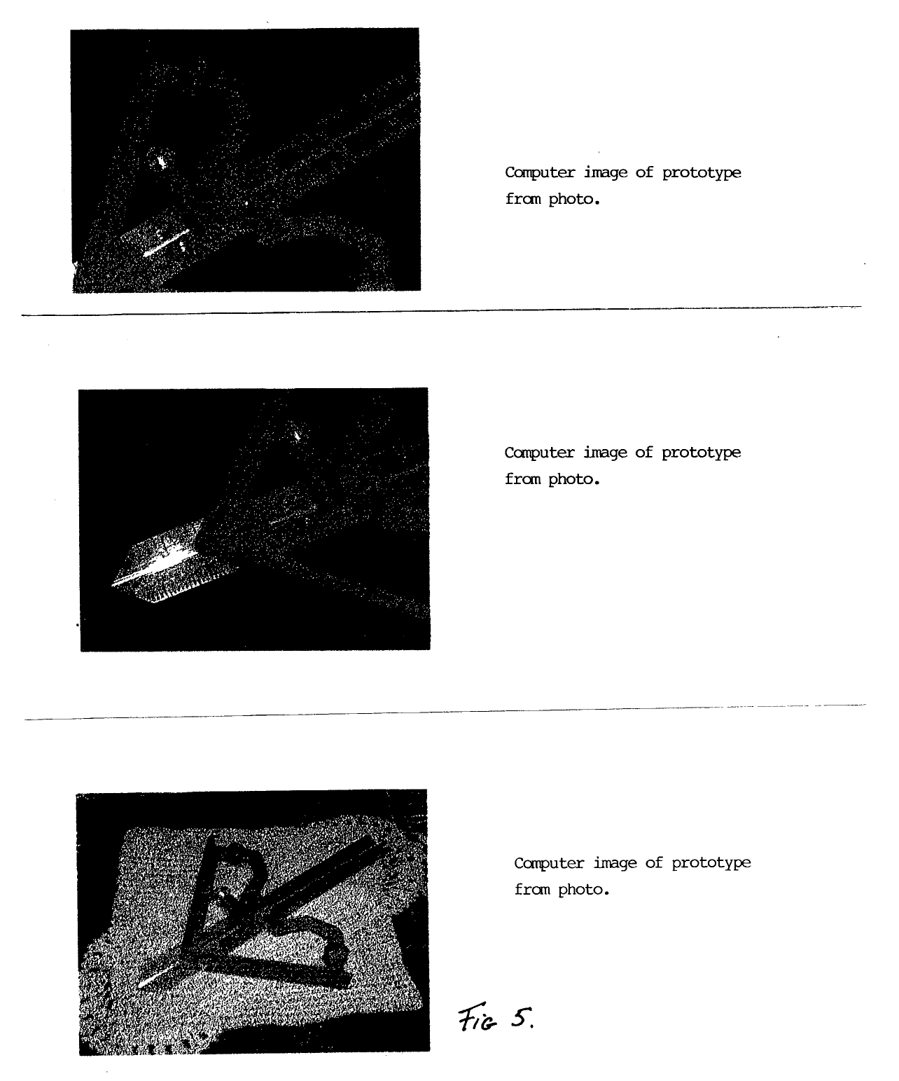

FIG. 5 is a computer image of prototype from photograph.

### DETAILED DESCRIPTION OF THE INVENTION

Referring to FIG. 1. The TRIM SETTING GAUGE is a hand held tool used in the trim carpentry field to set trim/casing in the application of trim carpentry. The TRIM SETTING GAUGE is comprised of the following parts:

Parts: #1 Outer casing

#2 Inner web

#3 Slid blade with channel

#4 Marking pin located in housing molded into web

#5 Housing for lock nut

#6 Lock nut

#7 Lock nut tension spring

My claim:

1. A tool used to achieve the desired margin when installing trim/casing in the carpentry field by locating the 90* set casing at edge and or right angle of a door or window jam, having set the adjustable blade to the desired depth and so becomes a one process maneuver due to the blade being set in the tool at a 45* angle. Once the intersecting location of the trim/casing is established the TRIM SETTING GAUGE is then moved horizontally and vertically on the jam to maintain a perfect and equal margin for the trim/casing.

1. A tool used to achieve the desired margin when installing trim/casing in the carpentry field by locating the 90* set casing at edge and or right angle of a door or window jam, having set the adjustable blade to the desired depth and so becomes a one process maneuver due to the blade being set in the tool at a 45* angle. Once the intersecting location of the trim/casing is established the Trim Setting Gauge is then moved horizontally and vertically on the jam to maintain a perfect and equal margin for the trim/casing.
